(19) United States
(12) Patent Application Publication
(10) Pub. No.: US 2026/0300486 A1
(43) Pub. Date: Oct. 1, 2026

(54) BINARY FILE THREAT DETECTION BASED ON PATTERN MATCHING RULE EMBEDDINGS

(71) Applicant: Red Hat, Inc., Raleigh, NC (US)

(72) Inventors: Andrea Cosentino, Milan (IT); Paolo Antinori, Milan (IT)

(21) Appl. No.: 19/092,747

(22) Filed: Mar. 27, 2025

(51) Int. Cl. G06F 21/56; G06F 21/62

(52) U.S. Cl. CPC G06F 21/564; G06F 21/6209; G06F 2221/033

(57) ABSTRACT

A method, a system, and a non-transitory computer-readable medium are provided. The method includes generating a pattern matching rule based on a binary file. The method includes converting, by a processing device, the pattern matching rule to an embedding. The method includes performing a similarity search for the embedding in a pattern matching rule embedding database to obtain a similarity score. The method includes determining whether the binary file is a security threat based on the similarity score.

### TECHNICAL FIELD

Aspects of the present disclosure relate to computer systems, and particularly to detecting binary file threats based on pattern matching rule embeddings.

### BACKGROUND

Computer systems are often targets of malware attacks, which may pose serious security risk. One way of detecting such attacks is based on pattern matching rules, such as Yet Another Recursive Acronym (YARA) rules, which rely on predefined string patterns or binary signatures to identify malware, such as malicious binary files that attempt to execute on the computer systems without authorization.

### BRIEF DESCRIPTION OF THE DRAWINGS

The described implementations and the advantages thereof may best be understood by reference to the following description taken in conjunction with the accompanying drawings. These drawings in no way limit any changes in form and detail that may be made to the described implementations without departing from the spirit and scope of the disclosure.

FIG. 1A is a block diagram that illustrates an example computer system, according to some implementations.

FIG. 1B is a block diagram that illustrates example binary file processing operations in a computer system, according to some implementations.

FIG. 2 is a flow diagram that illustrates operations for determining a security threat, according to some implementations.

FIG. 3 is a flowchart that illustrates an example method, according to some implementations.

FIG. 4 is a block diagram of an example computing device that may perform one or more of the operations described herein, according to some implementations.

### DETAILED DESCRIPTION

In computer systems, a binary file, often also called a non-text file, is a computer file whose content is programmed in a binary format that is not semantically understandable by humans. Binary files often constitute or include executable programs with the capability to access and make changes to a computer's hardware or software infrastructure. Because unauthorized execution of a binary file may pose serious security risk to a computer and a larger computer system, many computer systems are equipped with malware detection systems to detect and prevent threats from malicious binary files.

Existing YARA rule-based malware detection systems usually rely on predefined string patterns or binary signatures to identify malicious binary files. A YARA rule is a pattern matching rule for identifying patterns that are often in malware or malware. When a computing device finds a characteristic or a pattern that indicates a piece of malware based on the YARA rule, the computing device can raise a security alert of a possible malware attack. Typically, a YARA rule may be represented with three sections: 1) meta, such as the authors and metadata of the rule; 2) strings, which may be one or more static string sets that a static analysis of malware could return; and 3) condition, which may be a series of conditions, such as a regular expression, that correlate the strings.

However, these systems are sometimes limited by the static nature of YARA rules, which are often defined based on hard-coded string patterns. For example, existing systems often lack the flexibility to adapt to evolving, polymorphic, or obfuscated malware variants. The static nature of YARA rules often requires manually updating and maintaining large rule sets, which makes the malware detection systems cumbersome, costly, and prone to errors. Furthermore, the rigidity due to the static YARA rules makes it difficult for the malware detection systems to capture subtle similarities between new malware files and known threats. Accordingly, there is a need for a flexible and intelligent YARA rule-based malware detection mechanism that operates not based on exact pattern matching but also with the capability of similarity detection and automatic updating.

This disclosure provides techniques that address the challenges described above. As described in detail, one or more implementations of this disclosure provide a mechanism for detecting binary file threats by converting a binary file into a pattern matching rule embedding and detecting potential security threats based on a similarity search. According to some implementations, a computing device generates a pattern matching rule based on a binary file. A processing device of the computing device converts the pattern matching rule to an embedding. The computing device performs a similarity search for the embedding in a pattern matching rule embedding database to obtain a similarity score. The computing device then determines whether the binary file is a security threat based on the similarity score. Although the implementations described and illustrated in this disclosure are primarily based on YARA rules, other pattern matching rules may be used. With one or more features described below in detail, implementations of this disclosure advantageously improve the flexibility and accuracy of pattern matching rule-based malware detection, and, therefore, improve the security of computer systems.

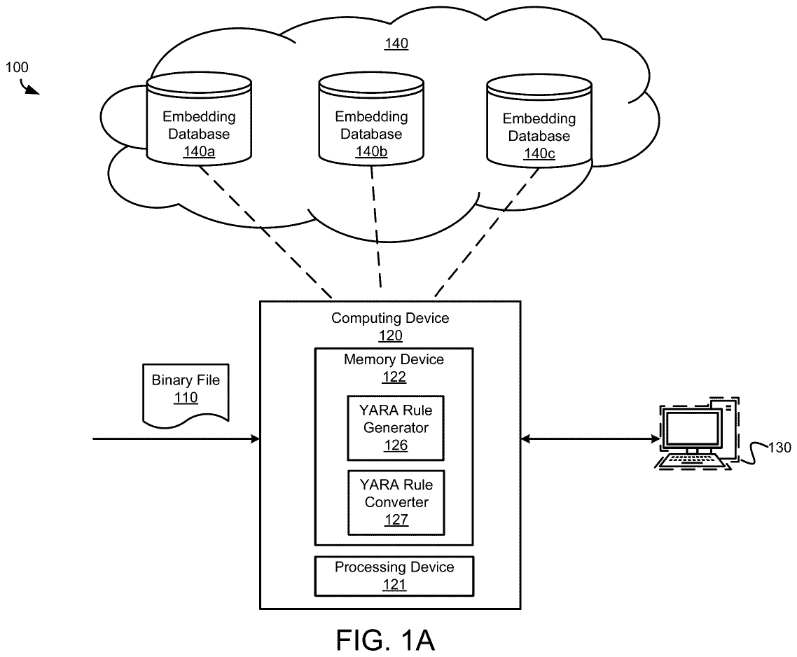

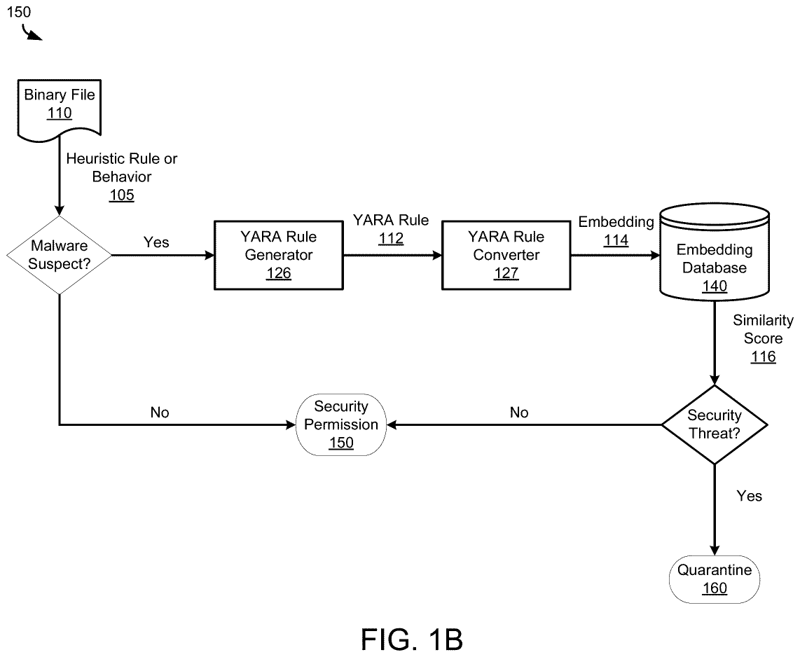

FIG. 1A is a system diagram that illustrates an example computer system 100, according to some implementations. As illustrated, computer system 100 includes computing device 120 communicatively coupled to computer 130. Computer system 100 receives binary file 110, e.g., from a device external to computer system 100, with binary file 110 attempting to visit and make change to computer 130.

Computing device 120 functions as a security checkpoint that receives binary file 110 before granting binary file 110 permission to be accessed by computer 130. Specifically, computing device 120 includes processing device 121 and memory device 122, which stores program instructions executable by processing device 121. To detect and prevent potential security threats posed by binary file 110, processing device 121 is configured to execute instructions corresponding to YARA rule generator 126 and YARA rule converter 127, which generate a YARA rule based on binary file 110 and convert the YARA rule to an embedding (or “embedding vector”), which may be a vector having a plurality of numeric values to represent information that a machine learning model is trained to process. For example, processing device 121 may generate the embedding to describe the YARA rule. Processing device 121 is also configured to execute instructions to perform a similarity search for the embedding in YARA rule embedding database 140, which includes one or more embedding database instances 140a, 140b, and 140c. Each of embedding database instances 140a, 140b, and 140c may store a set of embedding vectors representing YARA rules that correspond to known security threats posed by binary files. YARA rule embedding database 140 may be integrated within computing device 120, implemented as a separate component of computer system 100, or remotely situated away from computer system 100.

FIG. 1B is a flow diagram 150 that illustrates example binary file processing operations in a computer system, according to some implementations. The operations are described in the context of computer system of FIG. 1A.

As illustrated in FIGS. 1A and 1B, upon receipt of binary file 110, computing device 120 determines whether binary file 110 is a malware suspect based on criteria 105, which includes one or more heuristic rules or the behavior of binary file 110. Example criteria that computing device 120 may use in determining binary file 110 as a malware suspect include: i) binary file 110 has a size significantly larger or smaller than other files that computer 130 usually processes; ii) binary file 110 has a format, a header, or a file name that is inconsistent with the applications running on computer 130, iii) binary file 110 is received from an unknown or untrusted source device; or iv) binary file 110 attempts to visit (e.g., read, write, or modify) a protected or sensitive component or file of computer 130.

If binary file 110 is not identified as a malware suspect, then computing device 120 grants security permission 150 to binary file 110 such that binary file 110 may proceed with being accessed by computer 130. Conversely, if binary file 110 is identified as a malware suspect, computing device 120 utilizes YARA rule generator 126 to generate YARA rule 112 based on binary file 110. As an example, YARA rule generator 126 may deploy tools such as yarGen to obtain a string of bits from binary file 110 and generate YARA rule 112 based on the string. YARA rule generator 126 may create a file corresponding to YARA rule 112 on memory device 122 for YARA rule converter 127 to access. In some implementations where computer system 100 receives multiple binary files that are identified as malware suspects, YARA rule generator 126 deploys the same tool with the same parameters and configurations to generate multiple instances of YARA rule 112 respectively corresponding to the multiple malware suspects. This approach is helpful for maintaining consistency among the YARA rule instances.

YARA rule converter 127 then obtains YARA rule 112 and converts YARA rule 112 to embedding 114. In some implementations, YARA rule converter 127 deploys a machine learning model, such as a transformer-based large language model (LLM), to convert YARA rule 112 to a multi-dimensional embedding vector with numerical elements representing the signature, string patterns, and metadata of YARA rule 112.

Computing device 120 then performs a similarity search for embedding 114 in YARA rule embedding database 140 and obtains similarity score 116. As an example, computing device 120 may perform a k-nearest neighbors search using a cosine distance or a Euclidean distance to represent the similarity between embedding 114 and each embedding vector in embedding database 140. The similarity search returns similarity score 116 that quantizes the similarity of embedding 114 to the embedding vectors in embedding database 140. For example, similarity score 116 may be calculated to indicate the minimum cosine distance or Euclidean distance between embedding 114 and any embedding vector in embedding database 140, with the lowest possible distance indicating an exact match of embedding 114 in embedding database 140. The calculation of similarity score 116 may be different in other implementations.

As described above, embedding vectors in embedding database 140 represent YARA rules that correspond to known security threats. Accordingly, by using similarity score 116 to quantize the similarity of embedding 114 to the embedding vectors in embedding database 140, computing device 120 is capable of determining the level of similarity between binary file 110 and other binary files that are known as security threats.

Computing device 120 determines whether binary file 110 is a security threat based on the similarity score. In response to determining that binary file 110 is not a security threat, computing device 120 grants security permission 150 to binary file 110 such that binary file 110 is accessible by computer 130. In response to determining that binary file 110 is a security threat, computing device 120 blocks such access and sends binary file 110 to quarantine 160 for further security analysis. For example, computing device 120 may remove binary file 110 from memory device 122 or other storage devices, and move binary file 110 to a separate storage device or file directory that is de-coupled from computer 130. Computing device 120 may alternatively or additionally generate a report detailing, e.g., the source of binary file 110, the component that binary file 110 attempts to visit on computer 130, the application or user account that has requested binary file 110, the execution history of binary file 110, the closest known security threat indicated in the similarity search, etc. Computing device 120 may determine a level of the security threat and notify an administrator of computer system 100. Because computing device 120 has blocked binary file 110 from being accessed by computer 130, the administrator has time to analyze the security threat without interrupting the operations of computer 130.

In some implementations, embedding database 140 has the capability to learn about a newly discovered malicious binary file and update the database content to include one or more embeddings corresponding to the malicious binary file. For example, after determining that binary file 110 is a security threat, computing device 120 updates embedding database 140 to include embedding 114 as a new database entry. Accordingly, the next time computer system 100 receives a variant of binary file 110, computing device 120 may perform the similarity search in the updated version of embedding database 140 with improved accuracy and reliability. This way, embedding database 140 is able to grow its knowledge about malicious binary files. This may advantageously improve the robustness of computer system 100 against future security threats from unknown malware attacks.

In some implementations, embedding database 140 may be merged with one or more other YARA rule embedding databases to expand the content of the other YARA rule embedding databases. For example, in a network that includes computer system 100 (e.g., as a host server) and other user devices (e.g., as edge devices), each of the user devices may have a copy of embedding database 140. When computer system 100 detects binary file 110 as a security threat and updates embedding database 140, computer system 100 may further distribute the updated version of embedding database 140 to each of the user devices to improve the robustness of the user devices. In some implementations, instead of distributing an entire updated embedding database 140, computer system 100 may distribute only the difference between the original version and the updated version (e.g., embedding 114) to each user device, thereby reducing the data throughput and latency for installing the updates.

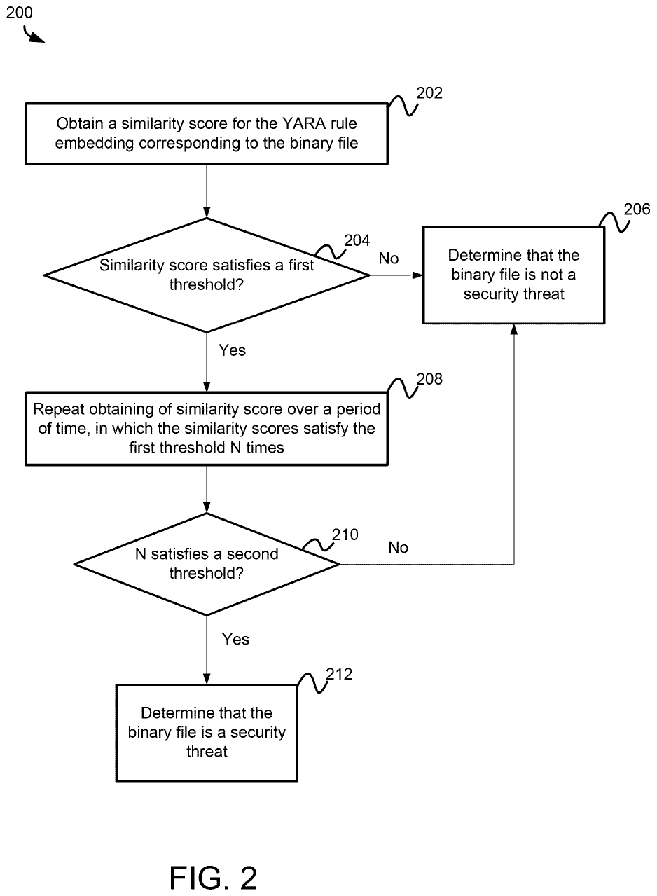

FIG. 2 is a flow diagram 200 that illustrates operations for determining a security threat, according to some implementations. Consistent with the illustration of FIG. 1B, the determination of the security threat is based on a similarity score, such as similarity score 116, that a computing device obtains at 202 by performing a similarity search for a YARA rule embedding that corresponds to a binary file.

At 204, the computing device determines whether the similarity score satisfies, e.g., exceeds, a first threshold. In the example of flow diagram 150, assuming a higher similarity score 116 indicates a higher similarity between embedding 114 and one or more of the embeddings in embedding database 140, computing device 120 may determine that binary file 110 has high likelihood of being a security threat if similarity score 116 exceeds the first threshold and has low likelihood if similarity score 116 is below the first threshold.

If the similarity score does not satisfy the first threshold, the computing device proceeds to the operation at 206 and determines that the binary file is not a security threat. With this determination, the computing device may grant a security permission to the binary file. In some implementations, along with granting the security permission, the computing device adds the binary file to a watchlist for further monitoring without quarantining the binary file or prompting an administrator to analyze the binary file.

If the similarity score satisfies the first threshold, the computing device proceeds to the operation at 208 to keep track of the similarity score, which may change over time due to the behaviors of the binary file or interactions between the binary file and other files or components of a computer system. To track the similarity score, the computing device repetitively performs similarity searches to obtain similarity scores over a period of time. The computing device counts the number of times N when the similarity scores satisfy the first threshold during the time period. For example, during a period of 10 seconds, the computing device performs similarity searches 10 times and finds that N=8 out of the 10 the similarity scores satisfy the first threshold.

At 210, the computing device determines whether N satisfies, e.g., exceeds, a second threshold. If the answer is Yes, the computing device considers that the high likelihood of security threat determined at 204 is reliable. The computing device thus proceeds to the operation at 212 and determines that the binary file is a security threat. If the answer is No, the computing device considers that the high likelihood of security threat determined at 204 is unreliable. The computing device thus proceeds to the operation at 206 and determines that the binary file is not a security threat. In some implementations where the computing device reaches 206 from 210, the computing device adds the binary file to a watchlist for further monitoring without quarantining the binary file or prompting an administrator to analyze the binary file.

In some implementations, some operations illustrated in flow diagram 200 are omitted. For example, the computing device in some implementations may directly determine that the binary file is a security threat if the operation at 204 returns Yes, without performing the operations at 208 and 210. As another example, the computing device in some implementations may always repeat the obtaining of the similarity score, without performing the operations at 202 and 204.

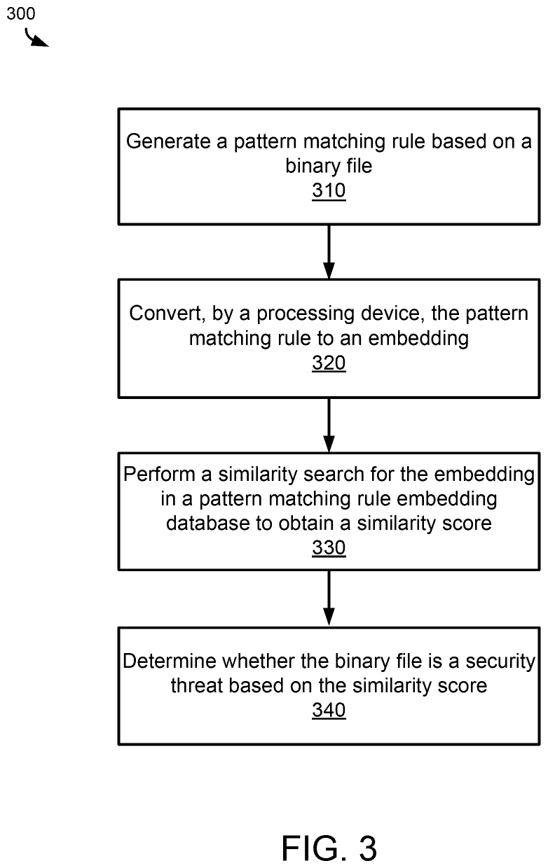

FIG. 3 is a flowchart that illustrates an example method 300, according to some implementations. Method 300 may be performed by a computing device, such as computing device 120 of FIG. 1A.

At 310, method 300 involves generating a pattern matching rule, e.g., a YARA rule, based on a binary file. In some implementations, the generation is based on a string of bits in the binary file.

At 320, method 300 involves converting, by a processing device, the pattern matching rule to an embedding. In some implementations, the conversion is based on a transformer of an LLM.

At 330, method 300 involves performing a similarity search for the embedding in a pattern matching rule embedding database to obtain a similarity score.

At 340, method 300 involves determining whether the binary file is a security threat based on the similarity score. In some implementations, in response to determining that the binary file is not a security threat, the computing device grants a security permission to the binary file. In response to determining that the binary file is a security threat, the computing device blocks access to the binary file.

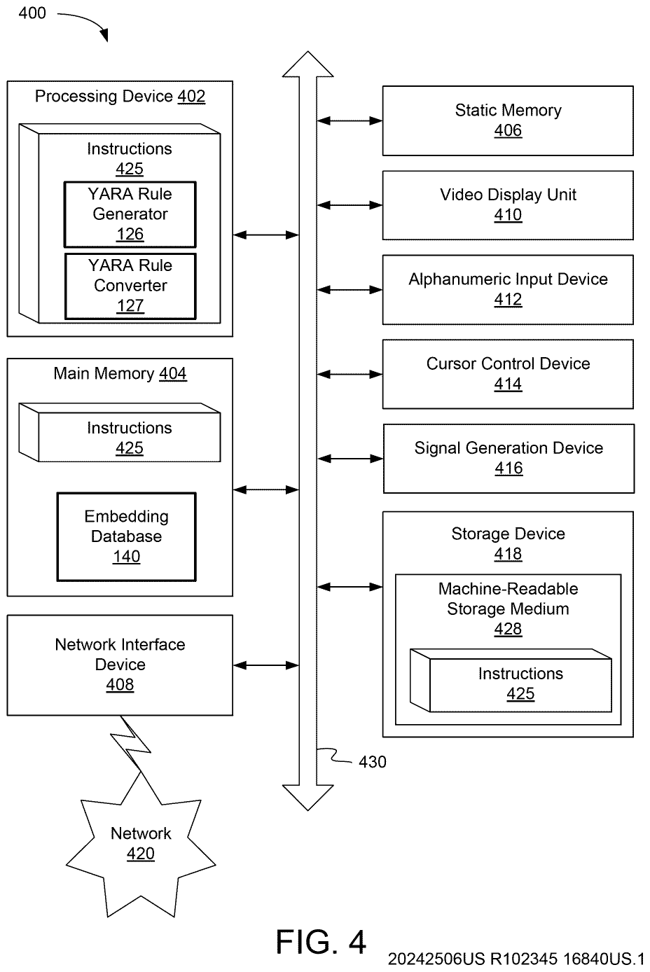

FIG. 4 is a block diagram of an example computing device 400 that may perform one or more of the operations described herein, in accordance with some implementations. For example, computing device 400 may be implemented to perform operations similar to those of computing device 120 of FIG. 1A. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

Computing device 400 may include a processing device (e.g., a general-purpose processor) 402, a main memory 404 (e.g., synchronous dynamic random access memory (DRAM), read-only memory (ROM)), and a static memory 406 (e.g., flash memory), which may communicate with each other via a bus 430.

Processing device 402 may be provided by one or more general-purpose processing devices, such as a microprocessor, central processing unit, or the like. For example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. Processing device 402 may be configured to execute the operations described herein, in accordance with one or more aspects of the present disclosure, for performing the operations and steps discussed herein.

Computing device 400 may further include a network interface device 408, which may communicate with a network 420. Computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and/or a signal generation device 416 (e.g., a speaker). In some implementations, video display unit 410, alphanumeric input device 412, and cursor control device 414 may be combined into a single component or device (e.g., an LCD touch screen).

Processing device 402 may execute instructions 425 to implement YARA rule generator 126 and YARA rule converter 127. Processing device 402 may also execute instructions 425 to access embedding database 140, which may be stored in main memory 404 or storage device 418.

During execution, processing device 402 fetches instructions from main memory 404 via bus 430. Computing device 400 may send or receive instructions 425 to or from network 420 via network interface device 408. In some implementations, computing device 400 further includes storage device 428, which may be a portable storage device that provides storage capacity. Main memory 404 and storage device 428 (if present) may both be implemented with a computer-readable storage medium.

While the term “computer-readable storage medium” is described as a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “receiving,” “configuring,” “identifying,” “transmitting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular implementations only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the embodiments and their practical applications, to thereby enable others skilled in the art to best utilize the implementations and various modifications as may be suited to the particular use contemplated. Accordingly, the present implementations are to be considered as illustrative and not restrictive, and the invention is not to be limited to the details given herein, but may be modified within the scope and equivalents of the appended claims.

What is claimed is:

1. A method comprising:
generating a pattern matching rule based on a binary file;
converting, by a processing device, the pattern matching rule to an embedding;
performing a similarity search for the embedding in a pattern matching rule embedding database to obtain a similarity score; and
determining whether the binary file is a security threat based on the similarity score.

2. The method of claim 1, further comprising:
receiving the binary file from an external device; and
determining the binary file as a malware suspect based on a heuristic rule or a behavior of the binary file.

3. The method of claim 1, wherein generating the pattern matching rule comprises:
obtaining a string of bits from the binary file; and
generating the pattern matching rule based on the string of bits.

4. The method of claim 1, wherein the conversion of the pattern matching rule is based on a transformer of a large language model (LLM).

5. The method of claim 1, wherein determining whether the binary file is a security threat comprises:
determining whether the similarity score of the binary file satisfies a threshold.

6. The method of claim 5, wherein determining whether the similarity score of the binary file satisfies the threshold comprises:
tracking the similarity score of the binary file over a time period; and
counting a number of times the similarity score satisfying the threshold over the time period.

7. The method of claim 1, further comprising:
in response to determining that the binary file is not a security threat, granting a security permission to the binary file; and
in response to determining that the binary file is a security threat, blocking access to the binary file.

8. The method of claim 1, further comprising:
generating an update of the pattern matching rule embedding database to include the embedding; and
distributing the update of the pattern matching rule embedding database to a user device.

9. The method of claim 1, wherein the pattern matching rule comprises a Yet Another Recursive Acronym (YARA) rule.

10. A system comprising:
a memory; and
a processing device operatively couple to the memory, to:
generate a pattern matching rule based on a binary file;
convert the pattern matching rule to an embedding;
perform a similarity search for the embedding in a pattern matching rule embedding database to obtain a similarity score; and
determine whether the binary file is a security threat based on the similarity score.

11. The system of claim 10, wherein the processing device is further to:
receive the binary file from an external device; and
determine the binary file as a malware suspect based on a heuristic rule or a behavior of the binary file.

12. The system of claim 10, wherein, to generate the pattern matching rule, the processing device is to:
obtain a string of bits from the binary file; and
generate the pattern matching rule based on the string of bits.

13. The system of claim 10, wherein the processing device is to convert the pattern matching rule based on a transformer of a large language model (LLM).

14. The system of claim 10, wherein, to determine that the binary file is a security threat, the processing device is to:
determine whether the similarity score of the binary file satisfies a threshold.

15. The system of claim 14, wherein, to determine whether the similarity score of the binary file satisfies the threshold, the processing device is to:
track the similarity score of the binary file over a time period; and
count a number of times the similarity score satisfying the threshold over the time period.

16. The system of claim 10, wherein the processing device is further to:
in response to determining that the binary file is not a security threat, grant a security permission to the binary file; and
in response to determining that the binary file is a security threat, block access to the binary file.

17. The system of claim 10, wherein the processing device is further to:
generate an update of the pattern matching rule embedding database to include the embedding; and
distribute the update of the pattern matching rule embedding database to a user device.

18. The system of claim 10, wherein the pattern matching rule comprises a Yet Another Recursive Acronym (YARA) rule.

19. A non-transitory computer-readable medium storing instructions that, when executed by a processing device, cause the processing device to:
generate a pattern matching rule based on a binary file;
convert the pattern matching rule to an embedding;
perform a similarity search for the embedding in a pattern matching rule embedding database to obtain a similarity score; and
determine whether the binary file is a security threat based on the similarity score.

20. The non-transitory computer-readable medium of claim 19, wherein, to determine that the binary file is a security threat, the instructions cause the processing device to:
determine whether the similarity score of the binary file satisfies a threshold.
